(19) United States
(12) Patent Application Publication
(10) Pub. No.: US 2005/0284413 A1
(43) Pub. Date: Dec. 29, 2005

(54) Training of animals using wireless communication and having spontaneous adjustment

(76) Inventors: Brian Boesch, Oak Hill, VA (US); Jon L. Roberts, Great Falls, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 10/865,466

(22) Filed: Jun. 10, 2004

(51) Int. Cl. A01K 15/02

(52) U.S. Cl. 119/720

(57) ABSTRACT

An animal training device for administering audio stimulus and physical encouragement to an animal. The trainer has a transmitter with variable signal strength. The animal worn device had a receiver that senses the signal strength. If the signal strength drops to a preset limit indicative of distance from the transmitter, a tone is sounded. Further signal drop results in a shock being delivered. In this way the animal learns the distance from the trainer that the animal can go without some form of restraint. The transmitted signal strength, and thus, the training perimeter, is spontaneously adjustable by the trainer at the transmitter.

### FIELD OF THE INVENTION

This invention relates generally to training of animals. More particularly the present invention is a form of wireless electronic leash and training aid for animals.

### BACKGROUND OF THE INVENTION

Animal training, particularly for household pets such as dogs, requires a great deal of patience. Further the training of dogs in particular has been the subject of many books for both owners as well as professional trainers regarding how to best train an animal to obey the wishes of its owner.

In the field of training, various devices have been invented which are designed to keep animals within a confined area. For example the now ubiquitous “electronic fence” is seen everywhere as a means of keeping animals within a specific area. The electronic fence comprises a wire surrounding an area in which an animal is to be confined. An electronic current placed on the wire giving it a magnetic field and/or the wire is used as an RF transmitter. A collar is then attached to the animal which is capable of sensing the electronic field. When the strength of the electronic field is at a certain level, an audible warning is given to the animal. As the animal gets closer to the buried wire, an electronic shock is administered to the animal thereby providing a physical incentive for the animal to stay away from the buried electrical wire. Over a training period of time, the animal become becomes familiar with the meaning of the audible sound and the general location of the buried wire. In this fashion the animal is trained to stay within a confined area by virtue of the audible signal and the electronic shock in the event that the animal gets too close to the buried wire.

However, animal owners cannot carry a buried wire wherever they go. As a result teaching an animal to “heel” must be accomplished by means of leashes and other physical means.

Animal control devices of various types have been the subject of much invention. For example, it has been proposed to have an animal worn radio signal receiver having appropriate electronics to receive a signal from an antenna and to administer both audible stimulation and electrical stimulation. For additional details, refer to U.S. Pat. No. 5,425,330 issued to Touchton et al.

It has also been proposed to provide a collar worn device having an antenna receiver controller and high voltage generator to administer a shock to an animal. This device relies upon the fact that electrical field strength with a receiving antenna decreases with distance from a transmitter. This invention relies upon a stationary transmitter to provide the appropriate signal. A shock is administered to the animal that strays beyond a distance from the transmitter. For additional details, refer to U.S. Pat. No. 4,898,120 issued to Brose.

Another proposal relies upon field strength changes to administer a shock to an animal based upon an animal worn device. Transmitters are stationary in defined locations where the animal is permitted and not permitted to go. For additional details, refer to U.S. Pat. No. 5,642,690 issued to Calabrease et al.

Another proposal takes the form of electronic fence and control device. The control device is worn by the animal and is combined with a radio frequency transmitter for generating radio signals. When the animal strays too close to a wire having a certain field strength a shock is delivered to the animal via an animal worn device. A provision is made for both audible stimulation and electrical stimulation when an animal strays too close to the limits of a defined area. For additional details, refer to U.S. Pat. No. 5,067,441 issued to Weinstein.

Another proposal comprises an animal worn device with an electrode for providing a shock to the animal. This system comprises a perimeter wire placed at the boundary of a defined space that sends a signal through the perimeter wire to generate a coded field. When the animal strays too close to the buried wire the collar delivers a electrical shock stimulus to the animal. This system is generally stationary with the receiver carried by the animal. For additional details, refer to U.S. Pat. No. 5,353,744 issued to Custer.

Yet another electronic containment system has been proposed wherein the animal or person wears a transceiver that also delivers an audible signal, a deterring shock or both when the person or animal leaves a predefined area. A stationary home base station detects and reads data transmitted from the transceiver. Again, one of the embodiments of this invention comprises a buried wire for defining a perimeter. Again a stationary system for transmission with, in this instance a transceiver, being worn by the individual or animal to be controlled. For additional details, refer to U.S. Pat. No. 5,844,489 issued to Yarnall et al.

Another proposal has an animal worn unit that comprises a GPS receiver, transmitter, and a programming unit that allows a person to program the location for a particular boundary in geographic terms. When a GPS signal is received that indicates the animal is near a predefined boundary, an electrical stimulation is administered. Thus the animal worn device in this instance comprises the stimulation means but also comprises a GPS receiver combined with an audible signal and electrical shock generation means. For additional details, refer to U.S. Pat. No. 5,868,100 issued to Marsh.

Another proposed system comprises an animal worn device capable of receiving an electronic signal and applying an adverse electrical stimulus and audible signal to control an animal. This invention discloses a portable transmitter that has certain buttons for administering sound, shock, and combination of both upon a specific actuation by the animal trainer. Various stimuli administered to an animal are administered only in response to push buttons that are depressed. For additional details, refer to U.S. Pat. No. 4,335,682 issued to Gonda et al.

Another proposed portable transmitter cooperates with an animal worn receiver that applies stimulation to the skin of the animal. In this instance the portable unit allows a trainer to select a stimulus to be applied to the animal when the trainer desires. For additional details, refer to U.S. Pat. No. 4,802,482 issued to Gonda.

Yet another proposal comprises a hand held transmitter that controls a receiver unit, which is attached to a collar worn by an animal to be trained. In this case voice commands are communicated to an animal via a speaker that is associated with the receiving unit worn by the animal. In the event that the animal disobeys a particular command, negative reinforcement is provided in the form of a mild electrical shock. For additional details, refer to U.S. Pat. No. 5,605,116 issued to Kim et al.

Another proposes system comprises an animal worn device for delivering audible or electrical stimulation to an animal if it fails to conform to expected behavior. A portable transmitter sends the signal that is desired by the animal trainer. Again in this instance the animal trainer takes positive action to transmit a RF control signal to the collar mounted receiver simulator unit. For additional details, refer to U.S. Pat. No. 5,054,428 issued to Farkus.

Another proposal uses yet another form of a GPS receiver type device. The animal worn GPS receiver comprises both the GPS system and an adverse stimuli-administering circuitry to shock the animal wearing the device. Thus not only can animal control be administered but the animal can be tracked as well. Adverse stimuli are applied using a hand held remote control unit to adversely stimulate the animal wearing the collar. The hand held unit determines the GPS position of the animal and administers a stimulus as desired by the trainer. Thus, the position of the trainer and the position of the animal are calculated and the trainer administers the shock as desired. For additional details, refer to U.S. Pat. No. 5,857,433 issued to Files.

A buried electric fence system is designed for confining the movement of an animal to a defined area. A radio signal is transmitted through an antenna that defines the area. This system is a form of buried wire system that defines a perimeter by virtue of the buried wire. A signal is sent through the buried wire such that when an animal approaches the wire, a collar worn receiver administers a mild electrical shock to the animal. For additional details, refer to U.S. Pat. No. 5,465,687 issued to Custer.

Yet another proposal provides an animal worn device that receives a signal from a transmitter. The animal worn receiver has a means to administer a stimulus to the animal. Both audible and electrical shock stimulus are administered to the animal when there is an electrical indication of a signal loss as when the animal wanders away from a predefined area. A fixed antenna transmits an RF signal to the collar worn device. For additional details, refer to U.S. Pat. No. 5,381,129 issued to Boardman.

Another animal worn control device has a receiver that receives a radio signal and a transducer for applying a stimulus to the animal in response to the signal. This invention addresses the programming apparatus associated with a programmable animal control device. This control device allows operating frequency of the receiver to be controlled the type and intensity of shock and audio stimulus as well as related perimeters. For additional details, refer to U.S. Pat. No. 5,533,469 issued to Touchton et al.

Thus it can be seen that much of the background art discloses animal collars and their circuitry, means for applying electrical shocks and audible stimuli to the animal worn device, a wide variety of “buried wire” systems together with associated stationary transmitters. All of which circuitry is disclosed in the references cited. Further several instances of portable transmitters are also illustrated for control of GPS, and for allowing animal trainers to administer shocks to animals when desired. Much of the circuitry in the references cited will be known by those skilled in the art to be applicable to the present invention.

However, what would be truly useful would be a system that comprises a form of “electronic leash” or training device which can be variably preset by an animal owner and operated in automatic mode to help train and control an animal when the owner and animal are moving such as when the owner is walking the animal. Such a system and method would allow the training of an animal to take place regardless of the location of the owner. Such a system would allow an owner to train an animal in the animal's own backyard and, when the owner and the animal are in another location other than the home. Such a system would be portable and operate without the need of a connection to household current at all times. Such a system would allow the owner to spontaneously alter the conditions of training by adjusting the training perimeter on the fly by adjusting the transmitted signal strength.

### SUMMARY OF THE INVENTION

It is therefore an objective of the present invention to be able to train animals.

It is a further objective of the present invention to train animals regardless of the location of where the owner and animal happen to be.

It is yet another objective of the present invention to train animals without the need for a leash.

It is still another objective of the present invention to train animals without the need for an electrical connection to a household current.

It is still another objective of the present invention to train animals using wireless technology.

It is a further objective of the present invention to allow wireless animal training apparatus to be adjustable so that various ranges for animal motion can be set.

It is further an objective of the present invention to allow the trainer using a wireless animal training apparatus to adjust on the fly the training perimeter by permitting spontaneous adjustment of the transmitted signal strength.

These and other objectives of the present invention will become apparent from a review of the specification that follows.

The present invention comprises a system and method for the training of animals. The present invention comprises two basic elements. The first element is the trainer device (TD). The trainer device is the device that is held by the trainer and has variable settings as will be more fully explained. The second element of the invention is the animal device (AD). The animal device is basically a receiver as will be more fully explained below.

The trainer device comprises a power supply, which can be a rechargeable or single use battery. The power supply supplies power to a processor that has certain variable settings as may be desired by the trainer. The processor is connected to an RF transmitter that transmits a radio signal having a limited range.

For purposes of training, the trainer may desire to set a range at which alarms of various types may be created for the animal being trained. This allows essentially a distance radius over which an animal may move before an alarm is given to the animal. This distance radius is variably set in the training device by the trainer. Thereafter the processor provides appropriate energy to the transmitter to allow the desired radius distance to be set.

In the beginning of a training session, the trainer may desire the animal to be kept very close in radius distance to the trainer. Once the animal is trained, the trainer can extend the radius distance by a simple setting on the training device.

The second element of the present invention is the animal device (AD). The AD comprises a power supply, which can be a rechargeable or single use battery. The animal device is worn as a collar around the animal so that the appropriate signals and physical encouragement can be applied. The animal device further comprises a receiver having the ability to measure signal strength. When signal strength is high, no audible or other physical indicator is given to the animal. When the receiver senses a signal strength at some intermediate level, an audible warning is given to the animal that it should not stray further from the trainer. If the signal strength descends to a low level, a physical “encouragement” in the form of a shock is given to the animal so that it does not stray farther from the trainer.

While training may initially occur with the use of some physical means such as a leash in order to both provide a physical feedback that is accompanied by the audible feedback, eventually the training device of the present invention will be able to be used without a physical restraining means by the trainer.

### BRIEF DESCRIPTION OF THE DRAWINGS

FIG. 1 illustrates the overall architecture of the present invention including the training device and the receiver.

FIG. 2 illustrates a general schematic of the training device.

FIG. 3 illustrates a general schematic of the animal device.

FIG. 4 illustrates an alternative embodiment of the present invention

FIG. 5 illustrates the animal-worn portion of the device of the present invention

FIG. 6 illustrates a leash embodiment of the present invention.

### DETAILED DESCRIPTION

As noted above, the present invention comprises both a system and method for animal training using a wireless training device and animal device. The present invention utilizes structural and procedural concepts disclosed in co-pending U.S. patent application Ser. No. 09/591,167, filed Jun. 9, 2000, which is incorporated herein by reference.

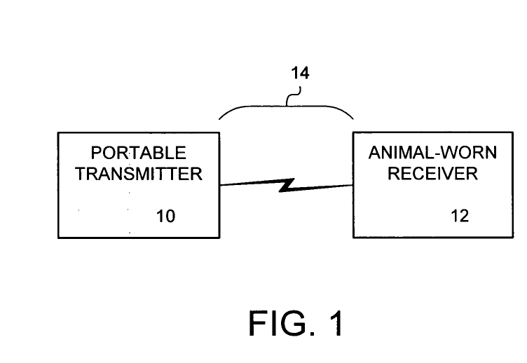

Referring first to FIG. 1, a generalized architecture of the present invention is illustrated. The trainer carries the training device 10 that comprises a transmitter for transmitting an RF signal to an animal device 12 worn by the animal. The radius distance 14 is configurable by the trainer.

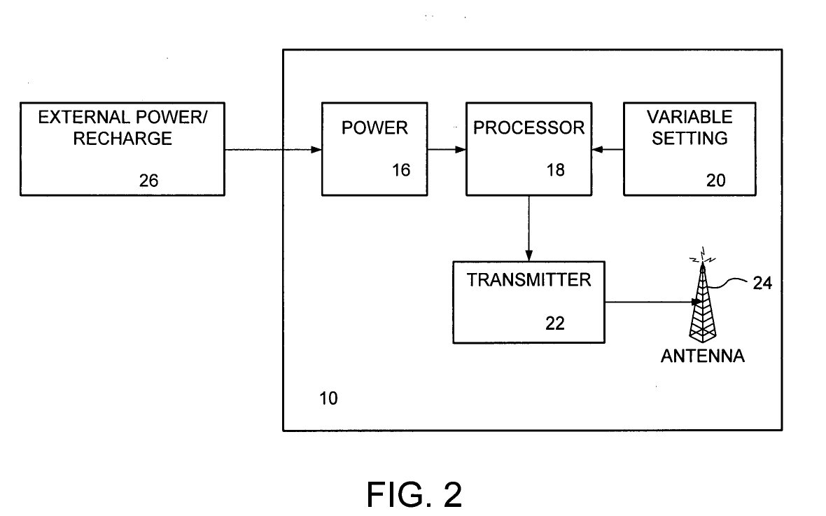

Referring to FIG. 2, the training device of the present invention is generally illustrated. Training device 10 comprises a power supply 16 which can be either a rechargeable or single use battery. In the event that the battery is a rechargeable one, the training device can be recharged with household current 26 or the battery can be removed from the unit and charged in a charger connected to household current.

The power supply is connected to a microprocessor 18 that comprises processing capability and for storage of variable parameters. The variable parameters are input by a variable setting means 20 which can be a dial, digital setting or other types of setting means known in the art. When the trainer desires to set a specific radius distance, such a distance in input in the variable setting 20 thus providing instructions to the processor 18.

Once the processor receives settings on the desired radius distance, the signal is sent to the transmitter 22 to apply the appropriate power to the transmission as instructed by the processor 18. A signal is then transmitted over antenna 24 which can then be received by the animal device 12. Depending upon the radius distance set by the trainer, the transmitted signal will be stronger or weaker as desired. The radius distance setting is adjustable on the fly by the trainer. This provides the trainer with the ability to spontaneously alter the conditions of training for the animal, without need to first bring the animal back into close proximity.

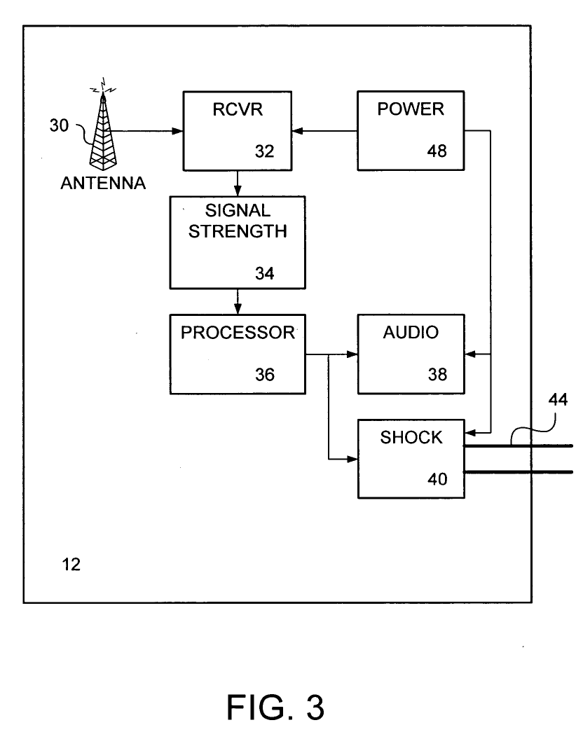

Referring to FIG. 3, the animal device is illustrated. Animal device 12 is a self-contained unit that is worn on a collar or other attachment to the animal. For example, a horse may the animal device in some form of harness whereas a dog may have it in a form of collar. The method of affixing the animal device to the animal is not meant as a limitation. Any means known in the art for affixing devices to animals is satisfactory for the present invention.

Animal device 12 receives the signal from training device 10 via an antenna 30. The antenna is connected to an internal receiver 32 that has the capability of receiving and digitizing the signal strength 34 so that the signal strength can be determined. Once the signal strength 34 is determined it is provided to a microprocessor 36 in the animal device. Micro processor 36 interprets the signal strength and, depending upon the level of the signal strength, sends a signal to an audible alarm 38 which in turn powers a speaker 42 which provides an audible signal to the animal when the signal strength is at some intermediate or warning level.

If the animal continues to wander further after hearing the audible alarm, the receiver 32 continually senses signal strength 34 and provides the appropriate digital signal to processor 36 that the signal is below a certain level indicative of a further radius distance from the trainer. When the signal strength drops below a certain level indicative that the animal has wandered farther than the trainer would desire, and beyond the audible signal 38 a signal is sent to an electric current generator 40 which then applies an electrical current via electrodes 44 to the animal administering a mild shock thereby providing a physical “encouragement” to the animal to return to the appropriate radius distance from the trainer.

The animal device also can operate from single use or rechargeable batteries 48 which provides power to the animal device. If rechargeable batteries are used, the entire unit can be plugged into household current or the batteries can be removed and recharged in a battery charger.

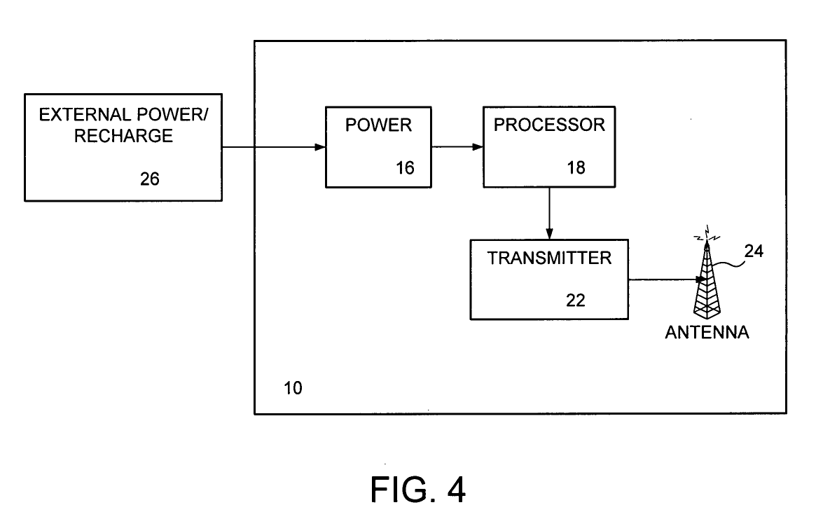

Referring to FIG. 4, an alternative embodiment of the present invention is illustrated. In this instance the variable setting is established by virtue of setting a radius distance on the animal device rather than on the trainer device. Thus FIG. 4 illustrates the trainer device having a somewhat more simplified architecture comprising a power supply 16 connected to a transmitter 22 which transmit over an antenna 24. Thus the need for a variable power setting in the transmitter is eliminated.

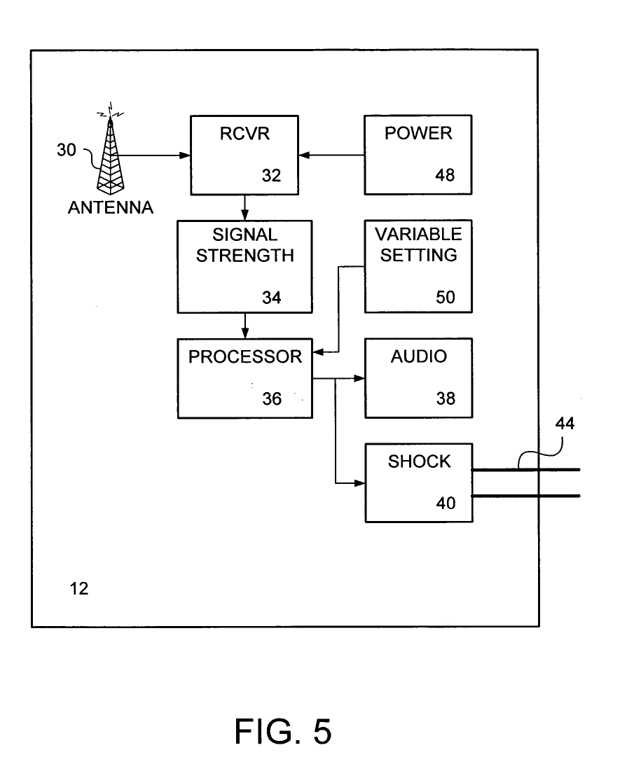

Referring to FIG. 5, the animal-worn portion of the device of the present invention is illustrated. In this instance animal device 12 comprises an antenna 30 which is connected to a receiver 32 in turn is powered by battery 48. The receiver 32 calculates signal strength 34 and inputs the signal strength information to processor 36. In this instance however the processor can receive variable settings from a variable input device 50. This device sets various levels within processor 36 indicative of the radius distance that the trainer desires to have and at which outer limits of radius distance signals an physical encouragements are provided to the animal. Once the variable setting is set 50 on the animal device 12 the processor 36 constantly monitors the signal strength 34 to determine whether an audible feedback to the animal should be given. If audible feedback is to be given 38 a tone is provided over speaker 42 to the animal. If the signal strength drops below a certain level as set by the variable setting 50 a shock is administered 40 to the animal over electrode 44.

As noted above part of the animal training process may require some physical restraint such as a leash in order to have the animal associate various distances with tones and shocks. However, once the animal learns of the various audible and physical signals, training can continue without the physical restraining means.

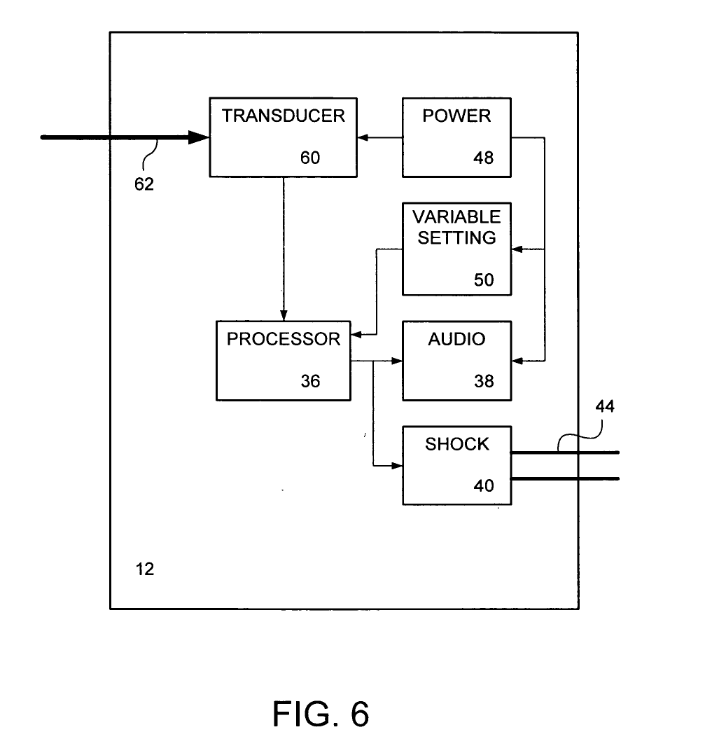

To further assist in training the animal and as noted above the animal worn portion of the present invention can also receive strength signals based upon the strength with which the animal pulls on the leash or lead of the owner. Referring to FIG. 6, the leash or lead embodiment of the animal-worn portion of the device of the present invention is illustrated. In this instance animal device 12 comprises a transducer 60 connected physically to the leash or lead either directly to the leash or via a transducer on the animal collar connected to the remaining circuitry of the present invention. The transducer or other similar strength measuring gauge such as spring, strain gauges or any other device capable of measuring and sensing the pull place on the leash or lead by the animal. The transducer is and the remaining portions of the system are powered by battery 48. The transducer 60 measures the signal strength placed on the leash by the animal and inputs the signal strength information to processor 36. In this instance however the processor can receive variable settings from a variable input device 50. This device sets various levels within processor 36 indicative of the strength of pull, and the limits, which the trainer desires to have and at which limits of pull a physical and/or audio encouragement is provided to the animal. Once the variable setting is set 50 on the animal device 12 the processor 36 constantly monitors the signal strength from transducer 60 to determine whether an audible feedback to the animal should be given. If audible feedback is to be given 38 a tone is provided over speaker 42 to the animal. If the signal strength exceeds the limit set by the trainer by the variable setting 50 a shock is administered 40 to the animal over electrode 44.

In this fashion the animal learns that pull too hard during a session results in negative reinforcement. Thus the animal learns not to pull.

A system and method for training of animals using a wireless device has been illustrated. It will be appreciated by those skilled in the art that certain of the background art provide the circuitry that contribute to the present invention. Other embodiments of the present invention are possible without departing from the scope of the invention as disclosed.

1. A lead-less animal training device comprising:
a portable transmitter providing transmission of an electromagnetic signal, the transmitter being adjustable to vary transmitted strength of the signal so as to provide a trainer the ability to spontaneously adjust signal strength; and
an animal-worn receiver wirelessly connected to the portable transmitter, the animal-worn receiver comprising a physical encouragement structure;
wherein the receiver is adapted to receive the signal from the transmitter indicative of the distance from the portable transmitter and is adapted to administer physical encouragement via the physical encouragement structure when the distance becomes greater than a threshold level.

2. The lead-less animal training device 1, wherein the animal-worn receiver further comprises:
a power source;
a signal strength meter connected to the power source and connected to produce a measure of the strength of the transmitted signal received; and
a processor connected to the power source and connected to the signal strength meter to receive the measure of the strength of the transmitted signal received;
wherein the physical encouragement structure comprises a shock producer connected to the power source and to the processor, and wherein the processor comprises instructions to cause the shock producer to administer a shock to the animal when the measure of the strength of the transmitted signal received reaches a first set signal strength threshold indicative of a shock.

3. The lead-less animal training device of claim 2, wherein the animal-worn receiver further comprises:
a sound producer connected to the processor for producing an audible tone;
wherein the processor comprises further instructions to cause the sound producer to generate an audible tone when the measure of the strength of the transmitted signal received reaches a second set signal strength threshold indicative of sound production.

4. The lead-less animal training device of claim 3 wherein the threshold indicative of sound production corresponds to a signal strength stronger than the threshold indicative of a shock.

5. An apparatus for training an animal to stay within a defined distance from a trainer regardless of whether the trainer is stationary or moving, the apparatus comprising:
a trainer device, the trainer device comprising a portable transmitter transmitting an RF signal, the portable transmitter being provided with an input for adjustment of the strength of the RF signal transmitted such that the trainer is capable of spontaneously adjusting signal strength;
an animal worn device, the animal worn device comprising a receiver for receiving the RF signal;
a signal strength sensor in the animal worn device for sensing the RF signal strength as the animal wearing the animal worn device moves about;
a processor in the animal worn device connected to the signal strength sensor comprising instructions for administering an audible signal to the animal when the signal strength falls below a first predefined signal strength level and for administering an electrical stimulus to the animal when the signal strength falls below a second predefined signal strength level, the predefined signal strength levels being indicative of the distance from the trainer to the animal.

6. The apparatus for training an animal of claim 5, wherein the portable RF transmitter continuously transmits the RF signal once the transmitter is turned on.

7. The apparatus for training an animal of claim 5, wherein the first and second signal strength levels are programmable in the animal worn device.
